(19) United States
(12) Patent Application Publication
(10) Pub. No.: US 2009/0156128 A1
(43) Pub. Date: Jun. 18, 2009

(54) EYEWEAR COMMUNICATIONS SYSTEM

(75) Inventors: Steven J. Franson, Scottsdale, AZ (US); Silviu Chiricescu, Chicago, IL (US); Derrick Lim, Queen Creek, AZ (US)

Correspondence Address: INGRASSIA FISHER & LORENZ, P.C. (MOT), 7010 E. Cochise Road, SCOTTSDALE, AZ, 85253, US

(73) Assignee: MOTOROLA, INC., Schaumburg, IL (US)

(21) Appl. No.: 11/954,810

(22) Filed: Dec. 12, 2007

(51) Int. Cl. H04B 7/00; G02C 1/00

(52) U.S. Cl. 455/66.1; 351/158

(57) ABSTRACT

An eyewear apparatus (100) has a first plurality of antennas (144, 142, 158) disposed thereon for transmitting a signal in a narrow beam (402), for example, with a directivity greater than 10 dBi, the signal comprising at least one of data and video. A microcomputer (126) is coupled to the first plurality of antennas for providing the signal thereto.

### FIELD

The present invention generally relates to eyewear, and more particularly to an eyewear communications system.

### BACKGROUND

Eyewear conventionally included, for example, glasses to improve vision by focusing objects, and binoculars to enlarge objects at a distance. In recent years as technology has advanced, eyewear now include displays for providing information including pictures and streaming video.

Binocular displays include head mounted displays such as glasses and helmet mounted displays wherein a virtual image is presented to each eye. The image, usually created by a microdisplay, for example an LCD screen, may be presented to the eye by means of refractive or reflective optics, such as through a lens system. Ideally the virtual images presented to each eye are perfectly aligned and the user perceives a single image similar to their perception of real images. The images may be stored within the eyewear or provided from another source.

Some known eyewear include cameras that record what is being seen and transmit the image omni-directionally to a remote display, while other eyewear may include displays for receiving video. Furthermore, known wireless technologies do not transfer at a high enough data rate to send the video data uncompressed and transmit at a high power that drains batteries.

Accordingly, it is desirable to provide eyewear that transmits information to a specific receiver at a low power expenditure. Furthermore, other desirable features and characteristics of the present invention will become apparent from the subsequent detailed description and the appended claims, taken in conjunction with the accompanying drawings and this background.

### BRIEF DESCRIPTION OF THE DRAWINGS

Embodiments of the present invention will hereinafter be described in conjunction with the following drawing figures, wherein like numerals denote like elements, and

FIG. 1 is an isometric view of eyewear in accordance with an exemplary embodiment;

FIG. 2 is schematic top view of the exemplary embodiment;

FIG. 3 is a typical circuit for summing received signals that may be used with the exemplary embodiment;

FIG. 4 is a schematic of a first signal transmitted from the exemplary embodiment;

FIG. 5 is a schematic of a second signal transmitted from the exemplary embodiment; and

FIG. 6 is a schematic of a third signal transmitted from the exemplary embodiment.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

Eyewear is disclosed that transmits information including messages and streaming video in a limited direction to a desired receiver, such as eyewear worn by others, thereby providing a more secure transmission. The eyewear includes antenna having overlapping beams or an arrayed antenna system for providing the transmitted beam, for example, with a directivity greater than 10 dBi (10 dB more directive than an isotropic antenna). The information may be transmitted in a burst to reduce power expenditure, and may be compressed for additional security of transmission. An omni-directional transmission may be accomplished by selecting specific antennas. A separate transmitter and receiver may be operated at different frequencies for power reduction. The eyewear provides enhancements with respect to human factors by providing a hands-free viewing experience and the ability to communicate with others in the immediate vicinity.

By utilizing transmission frequencies in the millimeter wave broadband developed by the IEEE 802.15.3 task group 3c (TG3c) of 57 to 64 GHz, for example, data rates of over 2 Gbps, and optionally over 3 Gbps, will be obtainable. At these frequencies, very small antennas may be utilized, for example, a patch antenna would require only about 2 mm². Additionally, this frequency range is in an oxygen absorption band and does not penetrate walls well (primarily line of sight), which assists in preventing unwanted eavesdropping. These advantages allow for a physically secure channel without any security overhead.

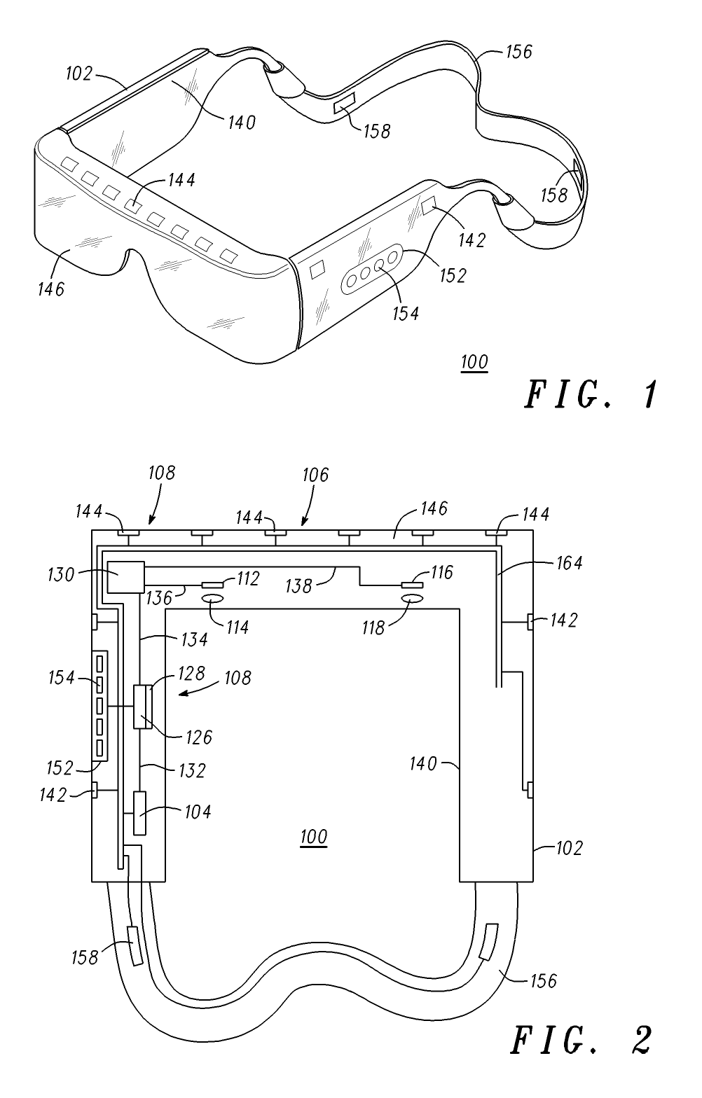

Referring to FIGS. 1 and 2, eyewear, and more specifically a binocular display device 100 in accordance with an exemplary embodiment, comprises a housing 102 including an image receiving device 104, optics system 106, and display modification system 108. The image receiving device 104 may, for example, comprise an input (not shown) for wired or wireless coupling or an electronic device for receiving and reading video data from a DVD or the like. The optics system 106 includes a first microdisplay 112 and a first lens 114 for displaying an image for an eye, and a second microdisplay 116 and a second lens 118 for displaying the image to the other eye. It should be understood that there are many types of optical systems that may include, for example, mirrors and/or waveguides. It should be understood the present invention should not be limited by the type of image receiving device 104 or the type of optics system 106 described herein. The display modification system 108 includes a microcomputer 126 and memory 128 coupled to the image receiving device 104, and a display driver 130 coupled between the microcomputer 126 and the microdisplays 112 and 116. The microcomputer 126 and/or the memory 128 may be integrated into the binocular display device 100 or may reside elsewhere and be coupled electronically to the binocular display device 100.

When an image, which typically would comprise a video stream, but could also comprise a text message or a picture, is received by the image receiving device 104, it is transmitted to the microcomputer 126 via first connector 132. The image is then transmitted to the display driver 130 via second connector 134, and to first and second microdisplays 112 and 116 via third connector 136 and fourth connector 138, respectively, for viewing.

While a video displaying eyewear is the preferred embodiment, other eyewear such as glasses used to focus an image may be used with the exemplary embodiments described herein.

The eyewear 100 in accordance with the exemplary embodiment includes antennas 142 positioned on support members 140 (for securing to a user head) of the housing 102, and antennas 144 positioned on the face member 146. Optionally, a flexible securing strap 156 may be attached to the support members 140 for securing the eyewear 100 to a users head, and may include additional antenna 158. Although the embodiment shown describes an apparatus similar to a pair of eye glasses, the apparatus may take other forms, such as a helmet. A control panel 152 including one or more inputs 154 is positioned on one of the support frames 140 and coupled to the microcomputer 126. The inputs 154 may be buttons, touch panels, and may include a curser moving input more commonly referred to as a mouse.

Information, for example, text or video, may be received by any of the antennas 142, 144, 158 and provided to the image receiving device 104 (which may be a receiver in some embodiments) via antenna bus 164, wherein the information is processed. The placement of the antennas 142, 144, 158 on each of the support frames 140, face plate 146, and flexible securing strap 156 provide reception regardless of which way the head (eyewear) is turned.

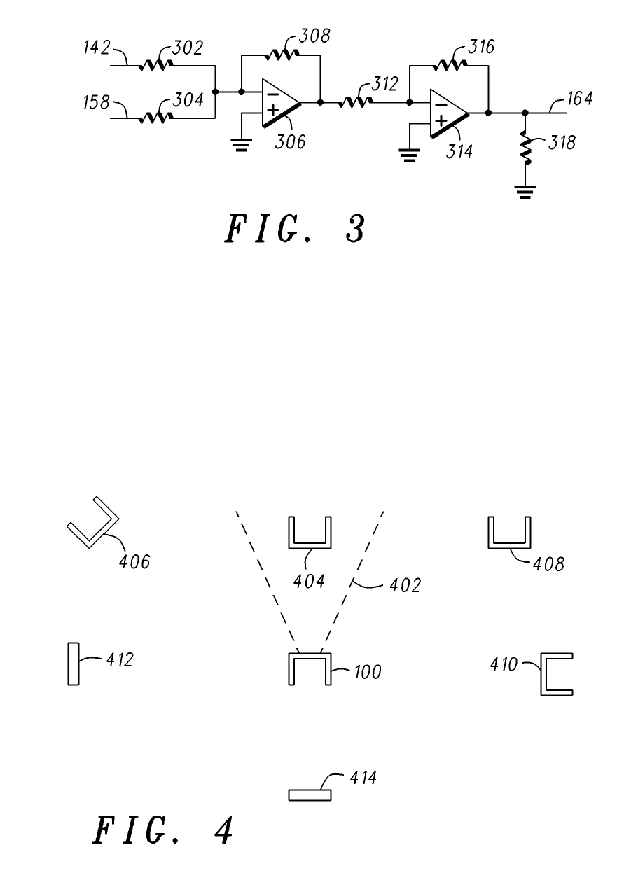

Placement of the antenna 142, 144, 158 circumferentially around the eyewear 100 (around the head) allows for reception, regardless of in which direction the transmission occurs. For example, if the transmitter is directly in front of the eyewear 100, the antennas 144 probably provide the best reception. If the transmitter is behind and to one side, the antennas 142 and 158 probably provide the best reception. FIG. 3 is exemplary circuitry that sums a signal received at one of the antennas 142 and one of the antennas 158. Resistors 302 and 304 are coupled between the antennas 142 and 158, respectively, and a negative input of operational amplifier 306. A feedback resistor 308 is coupled between the output of the operational amplifier 306 and its negative input. A negative input of operational amplifier 314 is coupled to the output of operational amplifier 306 by resistor 312, and is coupled to its output by feedback resistor 316. The positive inputs of operational amplifiers 306 and 314 are coupled to a reference potential, for example, ground. The output of operational amplifier 314 is coupled to the antenna bus 164, and to the reference potential by a resistor 318. This exemplary circuit of FIG. 3 is a variation of a typical op-amp summation circuit. Though two inputs from antennas 142, 158 are shown, additional inputs may be provided. Typically, a receiver (not shown) would be coupled between the antennas 142, 158 and resistors 302, 304.

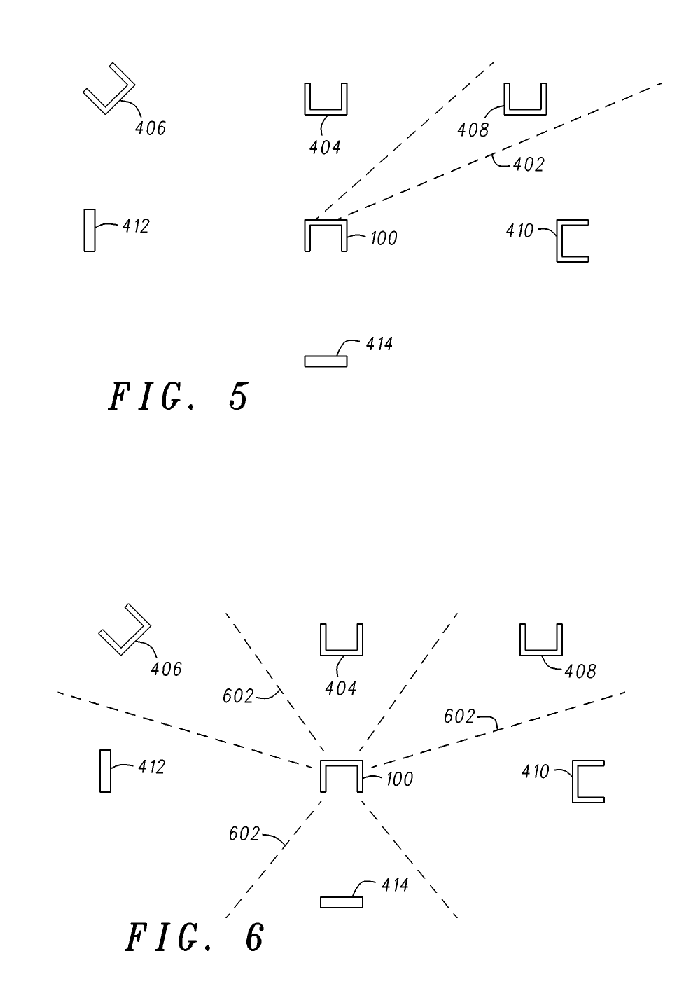

FIGS. 4-6 illustrate how the transmission capabilities of the eyewear 100 may be used. In FIG. 4, the antennas 144 (see FIG. 2) are connected in an array to transmit a directional signal 402 from the eyewear 100 to a specific receiver, such as eyewear 404. Since the transmitted signal 402 is directional, it is not received by the eyewear 406, 408, 410, and receivers 412, 414. The directional signal 402 may be transmitted to any of the other eyewear 406, 408, 410, and receivers 412, 414 by turning the head in their direction. Alternatively, the direction of the signal 402 may be changed by modifying the array pattern, resulting in the signal 402 being received by the eyewear 408, for example (FIG. 5). This may be accomplished by code within the transmitted signal or manually via the control panel 152. The directionality of the array may be determined by a signal, or beacon, received from the intended target eyewear 408. An indication of the transmitting eyewear 100 may be provided to the user of where the signal is being transmitted and the strength of the signal.

Optionally, an omnidirectional signal 602 may be transmitted to each the eyewear 406, 408, 410, and receivers 412, 414 (FIG. 6). This may be accomplished by code within the transmitted signal or manually via the control panel 152.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. An eyewear apparatus comprising:
a first plurality of antennas disposed on the eyewear apparatus for transmitting a signal in a narrow beam, the signal comprising at least one of data and video; and
a microcomputer coupled to the first plurality of antennas for providing the signal thereto.

2. The eyewear apparatus of claim 1 wherein the eyewear comprises:
a first supporting member;
a second supporting member; and
a faceplate disposed between the first and second supporting member, wherein the first plurality of antennas are disposed on the faceplate.

3. The eyewear apparatus of claim 1 further comprising a second plurality of antennas disposed on the first and second supporting members.

4. The eyewear apparatus of claim 3 further comprising a receiver disposed within one of the first and second supporting members and coupled to the circuitry.

5. The eyewear apparatus of claim 1 further comprising manual controls disposed on one of the faceplate, the first supporting member, or the second supporting member.

6. The eyewear apparatus of claim 1 further comprising a display configured to show the direction of the transmitted signal.

7. The eyewear apparatus of claim 1 further comprising a display configured to show the strength of the transmitted signal.

8. An eyewear apparatus comprising;
a faceplate;
a support member coupled to the faceplate;
a first plurality of antennas disposed on the faceplate;
a transmitter coupled to the first plurality of antennas; and
circuitry coupled to the first plurality of antennas for configuring the antennas to transmit a signal therefrom in a limited direction.

9. The eyewear apparatus of claim 8 further comprising a receiver for receiving the signal prior transmitting information by the antennas.

10. The eyewear apparatus of claim 9 further comprising a frequency converter coupled between the receiver and the transmitter.

11. A method for communicating from an eyewear apparatus, the apparatus including a plurality of antennas, comprising:
configuring at least a portion of the antennas to transmit a signal; and
transmitting the signal with a directivity greater than 10 dBi.

12. The method of claim 11 wherein the eyewear apparatus comprises a faceplate and the transmitting step comprises transmitting the signal substantially perpendicular to the faceplate.

13. The method of claim 11 wherein the limited direction is determined by software.

14. The method of claim 11 wherein the limited direction is determined by manual adjustment.

15. The method of claim 11 wherein the configuring step comprises configuring the at least a portion of the antennas as an array.

16. The method of claim 11 wherein the configuring step comprises configuring two of the antennas to have an overlapping beam.

17. The method of claim 11 wherein the configuring step further comprises configuring the antennas to transmit the signal omnidirectionally.

18. The method of claim 11 wherein the transmitting step comprises transmitting the signal in a series of bursts.

19. The method of claim 11 further comprising compressing the signal.

20. The method of claim 11 wherein the eyewear apparatus comprises a transmitter for performing the transmitting step, and a receiver for receiving the signal prior to the transmitting step, the method further comprising receiving the signal prior to transmitting the signal.

21. The method of claim 20 wherein the receiving step comprises receiving the signal at a first frequency, and the transmitting step comprises transmitting at a second frequency.
